(19) United States
(12) Patent Application Publication
(10) Pub. No.: US 2015/0178796 A1
(43) Pub. Date: Jun. 25, 2015

(54) Profile Based Rating Method and System

(71) Applicant: Robert Lin, Cupertino, CA (US)

(72) Inventor: Robert Lin, Cupertino, CA (US)

(21) Appl. No.: 14/138,067

(22) Filed: Dec. 21, 2013

(51) Int. Cl. G06Q 30/02

(52) U.S. Cl. CPC G06Q 30/0282

(57) ABSTRACT

A novel profile-based rating method and system are disclosed; where a plurality of profiles and their ratings are employed to indirectly represent the quality of products and services (objects), and to differentiate “good” versus “bad” products and services. A user establishes his association of favoritism with certain profiles through his rating feedback via a rating calculator in the system and uses his favorite profiles' ratings on objects as guidance for future selection. The advantages of the proposed profile-based rating method over the existing methods lies in its ability to mitigate the effects of unfair rating; and its ability to satisfy a variety of quality standards and tastes from a wide audience.

### FIELD OF THE INVENTION

The present invention relates to the review of product and service quality, and in particular, to a method of rating a product online.

### US PATENT REFERENCE

U.S. Pat. No. 6,996,444B2 Feb. 7, 2006 Ach III
U.S. Pat. No. 7,562,304B2 Jul. 14, 2009 Dixon et al.
U.S. Pat. No. 7,849,092B2 Dec. 7, 2010 Slaney et al.
U.S. Pat. No. 7,878,390B1 Feb. 1, 2011 Batten et al.
U.S. Pat. No. 7,930,190B1 Apr. 19, 2011 Milanovich
U.S. Pat. No. 7,933,961B2 Apr. 26, 2011 Mandel et al.
U.S. Pat. No. 7,958,127B2 Jun. 7, 2011 Edmonds et al.
U.S. Pat. No. 7,962,511B2 Jun. 14, 2011 Barney
U.S. Pat. No. 7,979,300B2 Jul. 12, 2011 Chandra
U.S. Pat. No. 8,015,484B2 Sep. 6, 2011 Backer
U.S. Pat. No. 8,090,621B1 Jan. 3, 2012 Chakrabarti et al.
U.S. Pat. No. 8,301,640B2 Oct. 30, 2012 Al Badrashiny et al.

### FOREIGN APPLICATION PRIORITY DATA

Dec. 28, 2012 2012122800232850 China Patent Office

### BACKGROUND OF THE INVENTION

Rating has been widely used to assess quality of objects and service as well as trustworthiness of human involvement. It is very widely used in e-commence and online communities and is a crucial and integral part of today's internet businesses, where people share their experiences, feedback and opinions to help others make better future decisions.

A common and popular online rating system is an accumulative rating system where an object of interest is advertised and offered by a provider and is evaluated by online users or members based on their experience with that particular object or with its provider. An evaluation is represented by a quantitative number in a preset range and is fed into the system to create a rating score based on the accumulative average of all inputs to reflect the overall quality and ranking of the object from users' point of view. Websites such as Yelp, IMDb, Amazon and eBay are some popular online systems with such an accumulative rating facility. In fact, such a system is the most widely used rating system online.

One important issue with the existing rating system is that the final rating score has an averaging effect; and in many cases one single quantitative score is incapable of reflecting the diversified tastes of a large population for an object under evaluation. For example, when an object to be evaluated is a type of food, it is hard to accurately judge the food qualities by an average score due to the fact that a person's taste in food is very subjective and that one person's delicacy is another's poison. A score from averaging user inputs will often mislead people on the actual quality of the food when applied to them personally. The same truth can be said for a particular movie as an object of interest.

Another issue with the existing rating system is the trustworthiness of the evaluation feedback itself where users may try to manipulate such a rating system by providing unfair evaluation scores in an attempt to skew the actual rating result. If enough such false scores enter into the rating system, it will ruin the rating quality and render the system untrustworthy. The trustworthiness of the existing rating system is a major challenge and a very expensive effort for e-commerce; especially when such a manipulation is often done collaboratively by a group of professional people.

Hence it is desirable to invent a more reliable rating system to meet diverse taste needs and to mitigate the influence of unfair ratings in order to increase the rating accuracy. This is the subject of the present invention.

### SUMMARY OF THE INVENTION

The present invention proposes a novel profile-based rating method and system to meet the needs of diverse tastes in the real world and to improve the rating accuracy by mitigating unfair ratings manipulation. The method and the system use a plurality of profiles as indirect representations of the quality of objects or services, where each profile gives its “expert” opinions and ratings on the complete set or on a subset of all the objects in the rating system, and make these ratings available to the public as a reference guide for future selections. In an embodiment of the proposed invention, users are not able to affect a profile's rating on an object through their rating feedback. A carefully designed rating filter mechanism based on a matching threshold will be able to eliminate the influence of unfair user feedback. Consequently users will not be able to manipulate the rating through their unfair rating feedback as with the existing systems. Instead, users' rating votes on objects under evaluation will be employed to rank the performance and popularity of profiles and to create the association of favoritism between a user and the profiles that fit the user's quality standard and taste preference.

A major advantage of the invention is that it is tamper resistant to unfair rating manipulation. Another advantage is that its rating result can satisfy the diverse tastes of the masses. In addition, the embodiment of the proposed invention is very simple and cost effective to implement in a real application.

### BRIEF DESCRIPTION OF THE DRAWINGS

The accompanying drawings illustrate the exemplary embodiments and describe and explain various principles of the invention.

FIG. 1 displays a block diagram of an exemplary computer online rating system.

FIG. 2 displays schematically the overview of an exemplary embodiment of the proposed profile-based rating system.

FIGS. 3a and 3b display one embodiment of data elements associated with a user and a profile in a computer system, respectively.

FIG. 4 displays a block diagram of the rating flow and operations for an embodiment of the proposed invention.

FIG. 5 displays one exemplary embodiment of the proposed invention for online movie review.

### DETAILED DESCRIPTION OF THE INVENTION

The present invention proposes a novel profile-based rating method and system to meet the needs of diverse tastes in the real world and to improve the rating accuracy by mitigating unfair ratings manipulation. Instead of rating the quality of objects directly, the method and the system use a plurality of profiles as indirect representations of the quality of these objects at interest, where each profile give its “expert” opinion and rating on the complete set or a subset of all objects at interest, and presents these ratings to public in the embodiment of the invention.

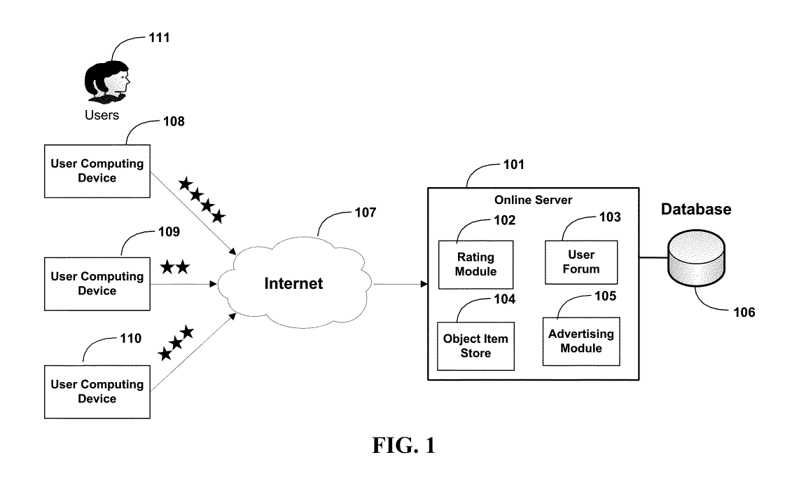

FIG. 1 shows an exemplary computer rating system typical with online service and product review websites where the accuracy of object rating is crucial for the success of business.

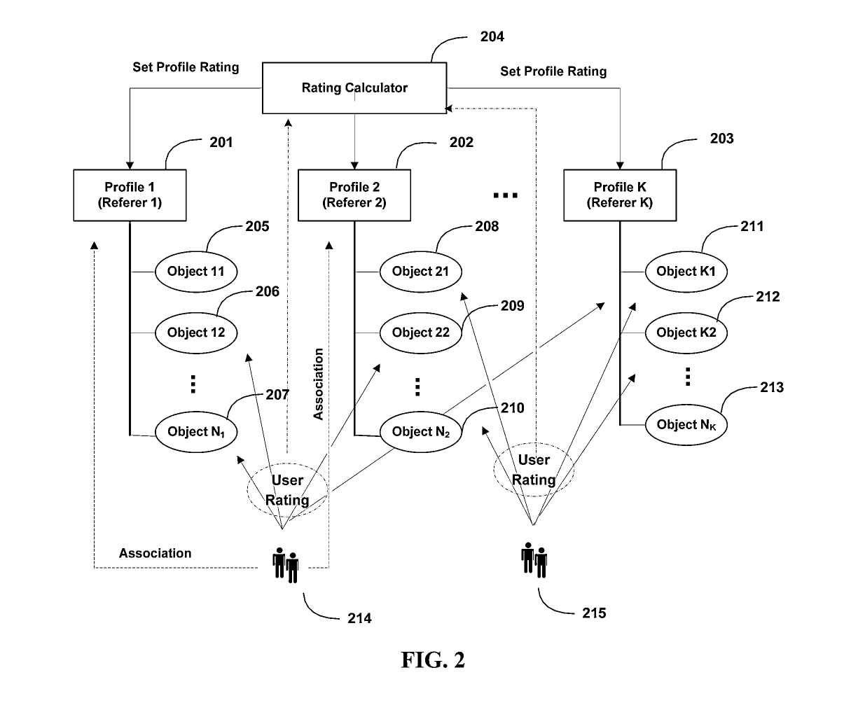

FIG. 2 displays schematically the architectural overview of one embodiment of the proposed invention that includes a plurality of profiles represented by 201-203, a Rating Calculator 204, a plurality of objects subset under each profile represented by 205-207 for profile 1, 208-210 for profile 2, 211-213 for the profile K, etc. where K represents the maximum number of profiles available in the system. And a plurality of users is represented by 214, 215 as exemplary groups.

In FIG. 2, every user can rate the quality of an object in said system with a rating score within a range designated by the system according his perception and taste, after he personally experiences the object.

In the embodiment system, a profile 201, a.k.a referrer, or an adviser in plain terms, has a subset of objects represented by 205-207 under its management and control, where it gives its rating for each and every one of these objects in the subset based on a profile's taste and judgment. The inclusion and the rating of each object in a profile's object subset are the decisions of each profile. Users of the rating system do not have influence on a profile's rating decision. Instead, users' ratings on each object will indirectly reflect in each profile's performance and popularity, and associations to said users. A good profile will be judged by users on the quality of its object collections under its management as well as by the accuracy and truthfulness of their ratings. The purpose of each profile in the embodiment is to be selected by users as potential quality references and selection guides on said objects in order to meet their personal tastes and needs. In essence, a profile serves as indirect indicator for the quality of these objects under its management. Instead of selecting an object based on the highest feedback rating score as in the existing systems, in the embodiment of the proposed invention, users will attempt to select those high rating objects from those profiles they like and with whom they share a close affinity for the same quality standard and tastes.

After selecting one or plural profiles as his quality guides and favorite references for the objects, a user will be able to use these profiles' subset or the full set of object collections as primary choices to speed up the selection of quality objects to fit his standard and taste, and to avoid time-consuming search.

In an ideal world, if a profile possesses true expertise and good judgment in its domain and is completely honest at providing its rating for all objects under its management, it will create a perfect rating system on all these objects for a specific taste associated with this particular profile. In reality, people will encounter similar quality and trust issues with the profiles themselves much the same way people are facing when rating the objects directly. Hence in order for the embodiment of rating system to work properly, there will be a need for a way to determine the quality of these profiles themselves and to keep good and truthful profiles and to drop unpopular and low quality profiles. This is the next part of the proposed invention that lets users' votes and ratings on objects translate these profiles into a proper ranking in order to differentiate profiles' quality.

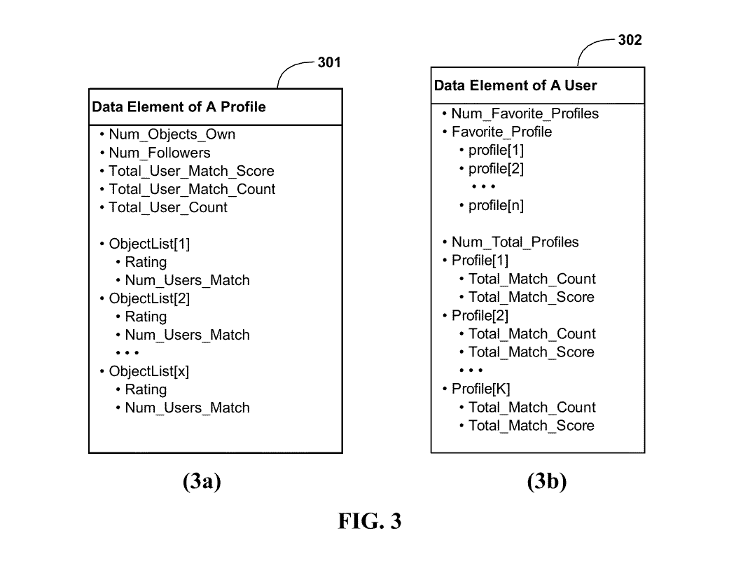

As shown in FIG. 3a, a profile in a computer system contains data items 301 to track objects and their ratings under its management as well as user's feedback rating to indicate profile's quality and ranking. It also contains data items to indicate the number of users following its recommendation of object ratings under its management. Similarly, as shown FIG. 3b, each user in the computer system contains data elements 302 to track the reflection of his vote on these profiles in order to associate the most appropriate profiles to match his specific rating quality and taste. It also contains some profiles the user chooses to follow as his favorite profiles for future reference.

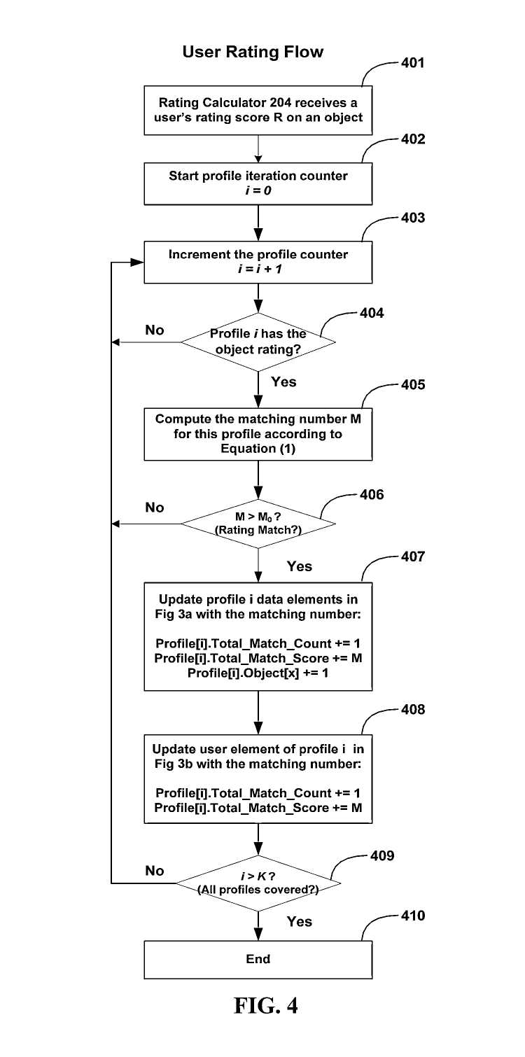

The rating process of the embodiment of the invention is shown in block diagram in FIG. 4 and is explained as follows. When a user rates an object with a score R in the range of [Rₘᵢₙ−Rₘₐₓ] set by the rating system, where a typical and popular score range is set at [0-5] or at [0-10], this rating score R is then fed into the system's Rating Calculator 204, where it follows the process shown in block diagram in FIG. 4. The user's rating score will be compared to every profile's rating score of the same object by the Rating Calculator when such a rating from a profile is available. The Rating Calculator first computes a matching number M between a user and a profile according to the following formula in equation (1):

$$M = 1 - \frac{\vert R - {R}_{p} \vert}{\vert {R}_{max} - {R}_{min} \vert} \qquad ( 1 )$$

where R is the user's rating score on the object and Rₚ the rating score on the same object from the profile under comparison. [Rₘₐₓ−Rₘᵢₙ] are rating score range set by the rating embodiment.

Based on the calculation result, the rating system of the embodiment decides if the user's rating matches a profile's rating according to formula in equation (2):

Rating is considered a match if M>M₀ (2)

where M₀ is a matching threshold chosen by the rating system that can be properly optimized and tuned according to the nature of objects to be rated and the system's service needs.

Using matching number M between the user's rating and the profile's rating and its corresponding matching criteria in Equation (2), the Rating Calculator 204 updates the associated data elements of this particular user who performs the rating and the data elements of each profile i, where i=1, . . . K, is set to iterate through all profiles in the system. If a matching number M is below threshold M₀ for a profile, the user's rating on the object for the said profile will simply be ignored.

The detail procedure is shown in FIG. 4 which is easily understood by one skilled in the field of computer science and engineering.

As shown in the update procedure in FIG. 4, a user's rating score R can affect every profile's data; hence its performance and popularity. The rating system can then use these profile data to properly rank each profile for public to select. One exemplary implementation is to rank profiles based on the average matching score according to the following Equation (3):

$$A Profile ' s Average Matching Score = \frac{Total\_User \_Match \_Score}{Total\_User \_Match \_Count} \qquad ( 3 )$$

The high average matching score indicates the closeness of users' ratings to a profile's published ratings on objects which this profile owns. It shows the likeness of the user to the rating opinions of the profile. This average score together with its “Num_Objects_Own”, “Total_User_Match_Count” and Total_User_Count data elements' statistics can be used to define a profile's quality rank, popularity and richness on object collection, which in turns are used by the rating system to added, to remove and to re-arrange profiles into the recommended ranking list of the embodiment of a rating system.

A user can associate a singular or a plurality of profiles of high ranking from his profile matching list to meet his quality standard and taste preference and to bookmark them as favorite profiles for later frequent references.

The advantage of the proposed rating method and system lies in its simplicity and resistance to manipulation and tampering. Since the rating of an object in each profile collection is set by the profile itself, users cannot change that rating per se via any unfair feedback. They will not be able to directly discredit the profile performance via their unfair feedback either. Assume that a profile with the right expertise and knowledge has rated a subset of objects under its management fairly. If a user decides to purposely provide false rating feedback on any of these objects, the score matching formula in equation (1) from the Rating Calculator 204 will discard his feedback as invalid due to the small Matching Number value resulting from the large discrepancies failing to pass the threshold. This will void this particular user's unfair feedback and consequently his manipulation. The embodiment of the invention can adjust the matching threshold criteria M₀ to fine tune the rating system to achieve its rating accuracy for its service needs.

Now imagine from the other end: the possibility that a rogue profile intentionally publishes its unfair rating on its objects in an attempt to manipulate the users. When a profile does attempt to do so, the majority users' fair rating on these objects will either result in few matches for this profile; or cause low matching score for its performance and ranking. All these will make it unattractive for users to follow. The embodiment rating system can easily identify such a low ranking rouge profile and remove it from the system.

Another advantage of the proposed invention is its ability to form a plurality of quality and performance standards to meet a wide range of user tastes and complex needs. This is especially true for objects (products) such as food, music, and etc, where likeness is subjective and there is no one single standard to meet the needs of population mass. The proposed invention can resolve this difficult problem by providing plurality of equally good profiles with different preferences to satisfy various tastes and standards from wide range of user groups.

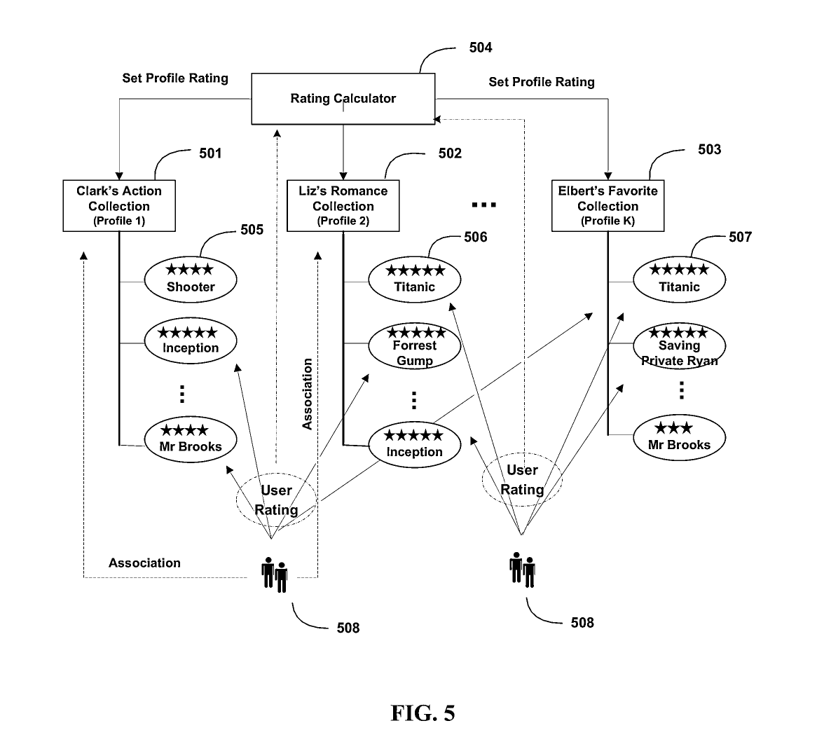

To better illustrate the proposed invention, a more concrete embodiment of the invention for an online movie review system similar to IMDb is illustrated in FIG. 5 and is described here. In the example embodiment, the abstract object is a concrete movie while the profile can be attributed to a movie advisor or recommender.

In the embodiment of the invention shown in FIG. 5, the plurality of exemplary profiles are shown as movie advisors Clark, Liz and Elbert, who, based on their views and tastes, have rated a subset of movie collections under their management with stars in the range of [0-5]. Due to individual views and tastes, the same movie can show up either with the same rating or with a different rating under each advisor. For example, the movie “Inception” is rated as 5-stars by both advisor Clark and Liz; while the movie “Mr Brooks” is rated by advisor Clark as 4-stars but is rated only at 3-stars by advisor Elbert. This rating individualism from each advisor (profile) is a good thing that it makes it possible to create a plurality of movie viewing standards and taste profiles to satisfy wide audience needs. Users of the embodiment of this rating system can associate their preferences and tastes to one or more advisors through the rating of each movie they watch and bookmark their favorite advisors for later movie recommendations and selections in the future.

Now consider the usage scenario for users Wendy and Robert. Assume the exemplary embodiment ranks profile Elbert as the top profile, where Wendy and Robert will initially select movies from its recommendation list. After consuming a certain quantity of movies including those under Elbert's list and those from other sources, and also participating in the rating of these movies, the embodiment rating system may generate a different profile ranking list for each user using said method and system depending on each user's taste and preference and their rating feedback. A possible scenario is that through rating iteration, user Robert may end up following Clark's movie list and recommendations while Wendy becomes happy following Liz's movie list due to different taste of both users. This exemplary scenario demonstrates the effectiveness of the proposed invention on achieving multiple quality standards to suit various tastes in the real world.

The embodiment of this movie rating system can publish and rank these advisors with the highest user matches and most user associations. This can significantly reduce a user's time searching for his favorite movies to watch and can greatly improve the service of the movie reviews website.

The invention of a profile based rating method and system for computer system has been described in detail with reference to an exemplary online embodiment in order to provide a skilled person with the information needed to apply the novel principles in an actual system. Although the embodiments of the present inventions have been described in detail, it should be understood that various changes, substitutions, and alterations could be made hereto without departing from the broader principles and scope of the invention. Accordingly, the specification and drawings are to be regarded as illustrative rather than restrictive.

What is claimed is:

1. A computer system for rating objects online, comprising:
a. a plurality of profiles to represent quality of objects or services under evaluation;
b. a module for correlating a user's rating on a object to the rating on the same object from said profiles in order to establish favoritism among said user and said profiles;
c. a module for computing a matching number between a user's rating and a profile's rating;
d. a module for a profile to manage its ratings on partial or complete objects under evaluation in the said computer system;
e. a module for tracking the matching statistics among a user and said profiles;
f. a module for updating said users and said profiles' information after each new rating is generated by a user; and
g. a module for establishing a ranking of said profiles for users to select online;

2. The system of claim 1, wherein said module for correlation of favoritism between a user and a profile is based on the closeness of accumulative ratings of said user to the corresponding ratings of said profile.

3. The system of claim 1, wherein on rating an object, a matching number is calculated by said computing module between the rating of a user and the rating of a profile; and wherein a threshold is used to determine if said matching number is valid for correlating the association between said user and said profile.

4. The system of claim 1, wherein said profile contains a list of ratings on a partial set or the complete set of objects under evaluation in said rating system; wherein each profile can contain a different list of objects with different ratings.

5. The system of claim 1, wherein said system further comprises a computer that maintains and records a list of statistics and information for the association of favoritism among a user and all the profiles in said system.

6. The system of claim 1, wherein a new rating from a user on an object causes said computer system to update said statistics information among said user and said profiles.

7. The system of claim 1, wherein said rating system ranks profiles online as candidates for selection according to matching statistics among said users and said profiles.

8. A method for rating objects online, comprising:
a. a step of establishing a plurality of profiles to represent the quality of objects or services under evaluation;
b. a step of correlating a user's rating on a object to the rating on the same object from said profiles in order to establish favoritism among said user and said profiles;
c. a step of computing a matching number between a user's rating and a profile's rating;
d. a step of managing a profile's ratings on a partial set or the complete set of objects under evaluation in the said computer system;
e. a step of tracking the matching statistics among a user and said profiles;
f. a step of updating said users and said profiles' information after each new rating is generated by a user; and
g. a step of establishing a ranking of said profiles for users to select online;

9. The method of claim 8, wherein the step of correlating the favoritism between a user and a profile is based on closeness of accumulative ratings of said user to the corresponding ratings of said profile.

10. The method of claim 8, wherein at rating an object, the step of computing a matching number is calculated between the rating of a user and the rating of a profile; and wherein a threshold is used to determine if said matching number is valid for correlating the association between said user and said profile.

11. The method of claim 8, wherein said profile contains a list of ratings on a partial set or the complete set of objects under evaluation in said rating system; wherein each profile can contain different list of objects with different ratings.

12. The method of claim 8, wherein a computer that maintains and records a list of statistics and information for the association of favoritism among a user and all the profiles in said system.

13. The method of claim 8, wherein the step of establishing a new rating from a user on an object causes said computer system to update said statistics information among said user and said profiles.

14. The system of claim 8, wherein said step of rating ranks profiles online as candidates for selection according to matching statistics among said users and said profiles.

15. A non-transitory computer readable medium having a computer program contains the instructions executing a process for rating objects online, comprising:
a. a step of establishing a plurality of profiles to represent quality of objects or services under evaluation;
b. a step of correlating a user's rating on a object to the rating on the same object from said profiles in order to establish favoritism among said user and said profiles;
c. a step of computing a matching number between a user's rating and a profile's rating;
d. a step of managing a profile's ratings on partial or complete objects under evaluation in the said computer system;
e. a step of tracking the matching statistics among a user and said profiles;
f. a step of updating said users and said profiles' information after each new rating is generated by a user; and
g. a step of establishing a ranking of said profiles for users to select online;

16. The medium of claim 15, wherein the step of correlating the favoritism between a user and a profile is based on closeness of accumulative ratings of said user to the corresponding ratings of said profile.

17. The medium of claim 15, wherein at rating an object, the step of computing a matching number is calculated between the rating of a user and the rating of a profile; and wherein a threshold is used to determine if said matching number is valid for correlating the association between said user and said profile.

18. The medium of claim 15, wherein said profile contains a list of ratings on a partial set or the complete set of objects under evaluation in said rating system; wherein each profile can contain different list of objects with different ratings.

19. The medium of claim 15, wherein the step of rating further comprises process that a new rating from a user on an object causes said computer system to update said statistics information among said user and said profiles.

20. The medium of claim 15, wherein said step of rating ranks profiles online as candidates for selection according to matching statistics among said users and said profiles.
